(19) United States
(12) Patent Application Publication
(10) Pub. No.: US 2020/0374367 A1
(43) Pub. Date: Nov. 26, 2020

(54) SERVICE PROVIDING SYSTEM AND SERVICE PROVIDING METHOD

(71) Applicant: Noboru HISHINUMA, Kanagawa (JP)

(72) Inventor: Noboru HISHINUMA, Kanagawa (JP)

(73) Assignee: Noboru HISHINUMA, Kanagawa (JP)

(21) Appl. No.: 16/635,509

(22) PCT Filed: Jul. 31, 2017
(86) PCT No.: PCT/JP2017/027671

§ 371 Date: Feb. 25, 2020

(51) Int. Cl. H04L 29/08; G06F 21/42

(52) U.S. Cl. CPC H04L 67/325; G06F 21/42; G06F 2221/2103; H04L 67/04; H04L 67/303

(57) ABSTRACT

A service providing system (1) includes an authentication device (200) that includes an information communicator that receives authentication information obtained by performing a predetermined processing on a phone number of a user that has a right to use a service. The authentication device (200) further includes a number authenticator that, when there is an incoming call from a terminal (300), performs authentication of the terminal (300) on the basis of the received authentication information, and information obtained by performing the predetermined processing on the phone number that is notified together with the incoming call. The service providing system (1) further includes a service providing device (100) that provides the service when the authentication is successful.

### TECHNICAL FIELD

The present disclosure relates to a service providing system and a service providing method.

### BACKGROUND ART

In the background art, systems are known that provide a service to a user, which uses a mobile phone, when authentication, based on a caller number that is notified together with an incoming call from the mobile phone and a phone number of a user that has a right to use the service (see, for example, Patent Literature 1), is successful.

### CITATION LIST

### Patent Literature

Patent Literature 1: Unexamined Japanese Patent Application Publication No. 2015-111329

### SUMMARY OF INVENTION

### Technical Problem

However, with the system disclosed in Patent Literature 1, after the mobile phone places an outgoing call to the authentication device, the user operates the mobile phone to send, to a service providing device, a notification indicating the completion of the outgoing call. When the notification indicating the completion of the outgoing call is received, the service providing device sends a request to the authentication device to perform authentication using the phone number.

One reason such operations are necessary is because there are cases in which an application (hereinafter referred to as “app”) executed by the mobile phone is unable to detect the completion of the outgoing call. For example, the time required to make outgoing calls may be longer in cases in which the outgoing call is made in a location where many people use mobile phones, such as terminal train stations, or in cases in which the outgoing call is made when a high volume of payments are made, such as on days of the month ending in 5 or 0.

Therefore, in cases in which the mobile phone is unable to detect the completion of the outgoing call due to it being difficult to predict how much time must elapse for the outgoing call to complete, if there is no user operation of the mobile phone, the app must repeatedly send requests to the service providing device by performing polling processing over a predetermined period. Since the service providing device is a web server, a program that requests authentication to the authentication device must be loaded into the memory each time a request is received from a mobile terminal and, as such, the load on the service providing device increases.

Consequently, with the system disclosed in Patent Literature 1, after the outgoing phone call, the user must operate the mobile phone to send, to the service providing device, a notification indicating completion of the outgoing call, which places a burden on the user. Additionally, there is a problem in that attempting to reduce the operation burden on the user causes the load on the service providing device to increase due to the processing of repeatedly requesting authentication using the phone number.

The present disclosure is made with the view of the above situation, and an objective of the present disclosure is to provide a service providing system and a service providing method whereby increases in the load on the service providing device can be suppressed while reducing the operation burden on the user compared to conventional technologies.

### Solution to Problem

A service providing system according to the present disclosure that achieves the objective described above includes:

an authentication device including
an information communicator that receives authentication information obtained by performing a predetermined processing on a phone number of a user that has a right to use a service, and
a number authenticator that performs, when there is an incoming call from a terminal after the authentication information is received, authentication of the terminal on the basis of the received authentication information, and information obtained by performing the predetermined processing on the phone number that is notified together with the incoming call; and
a service providing device that provides the service when the authentication is successful.

### Advantageous Effects of Invention

With the service providing system and the service providing method according to the present disclosure, it is possible to suppress increases in the load on the service providing device while reducing the operation burden on the user compared to conventional technologies.

### BRIEF DESCRIPTION OF DRAWINGS

FIG. 1 is a configuration drawing illustrating a configuration example of a service providing system according to Embodiment 1 of the present disclosure;

FIG. 2 is a configuration drawing illustrating an example of the hardware configuration of a service providing device;

FIG. 3 is a flowchart illustrating an example of the first half of service provision processing executed by the service providing device;

FIG. 4 is a flowchart illustrating an example of the second half of the service provision processing executed by the service providing device;

FIG. 5 is a functional block diagram illustrating an example of functions of the service providing device;

FIG. 6 is a drawing illustrating an example of a client table that the service providing device stores;

FIG. 7 is a configuration drawing illustrating an example of the hardware configuration of an authentication device;

FIG. 8 is a flowchart illustrating an example of request rejection determination processing executed by the authentication device;

FIG. 9 is a functional block diagram illustrating an example of functions of the authentication device;

FIG. 10 is a drawing illustrating an example a number authentication table that the authentication device stores;

FIG. 11 is a functional block diagram illustrating an example of an authentication information locker of the authentication device;

FIG. 12 is a flowchart illustrating an example of number authentication processing executed by the authentication device;

FIG. 13 is a configuration drawing illustrating an example of the hardware configuration of a terminal;

FIG. 14 is a flowchart illustrating an example of service use processing executed by the terminal; and

FIG. 15 is a configuration drawing illustrating a configuration example of a service providing system according to Embodiment 2 of the present disclosure.

### DESCRIPTION OF EMBODIMENTS

### Embodiment 1

Hereinafter, a service providing system 1 according to Embodiment 1 of the present disclosure is described while referencing the attached drawings.

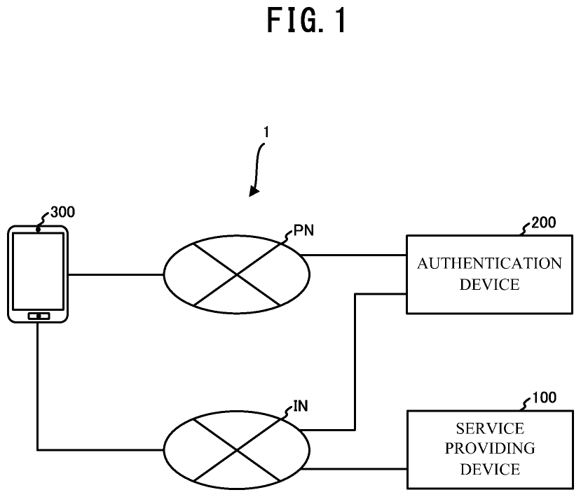

The service providing system 1 illustrated in FIG. 1 includes a service providing device 100, an authentication device 200, and a terminal 300.

The service providing device 100 is a server device, and is connected to the authentication device 200 and the terminal 300 via an internet IN. When authentication of the terminal 300 by the authentication device 200 is successful, the service providing device 100 provides a service such as online banking or online trading to the terminal 300.

The authentication device 200 is a sever device, and is connected to the service providing device 100 via the internet IN and is connected to the terminal 300 via a public network PN. In response to an authentication request from the service providing device 100, the authentication device 200 uses a caller number notified together with an incoming call from the terminal 300 to authenticate that the terminal 300 is being used by a user that has a right to receive the service (hereinafter referred to simply as “authorized user”).

The terminal 300 is a smartphone, and is connected to the authentication device 200 via the public network PN. In accordance with a user operation, the terminal 300 places an outgoing phone call to a number assigned to the authentication device 200 and, as a result, is subjected to authentication using the caller number. Additionally, the terminal 300 is connected to the service providing device 100 via the internet IN and, when the number authentication is successful, carries out information communication in accordance with user operations to use the service provided by the service providing device 100.

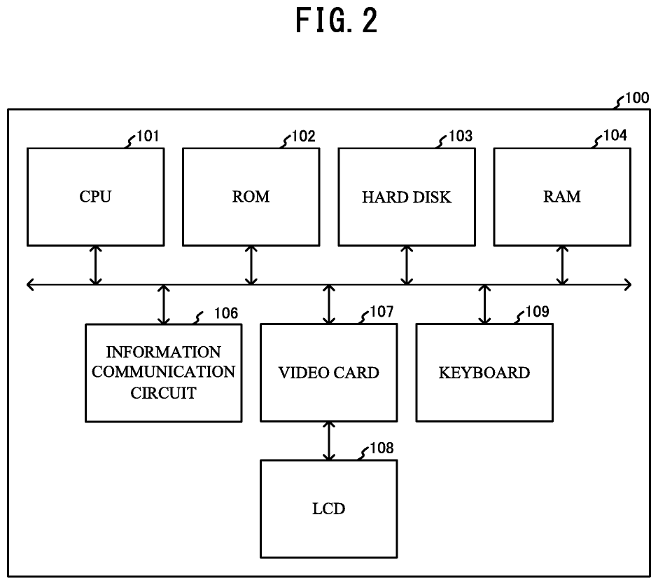

Next, the configuration of the service providing device 100 that provides the service to the terminal 300 will be described while referencing FIG. 2.

The service providing device 100 includes a central processing unit (CPU) 101 that executes a program, a read-only memory (ROM) 102 and a hard disk 103 that save the program, and a random access memory (RAM) 104 that is used as the working area when executing the program.

The service providing device 100 also includes an information communication circuit 106 that carries out information communication with the service providing device 100 and the terminal 300 via the internet IN illustrated in FIG. 1 when executing the program.

Furthermore, the service providing device 100 includes a video card 107 that draws images on the basis of signals output from the CPU 101 and outputs image signals representing the drawn images, and a liquid crystal display (LCD) 108 that displays images on the basis of the image signals. Additionally, the service providing device 100 further includes a keyboard 109 that inputs signals corresponding to user operations.

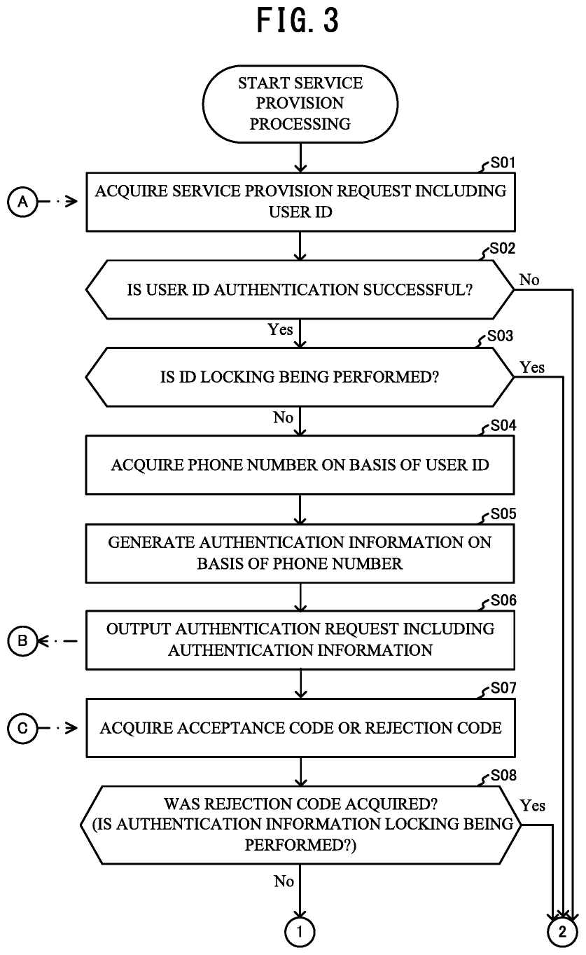

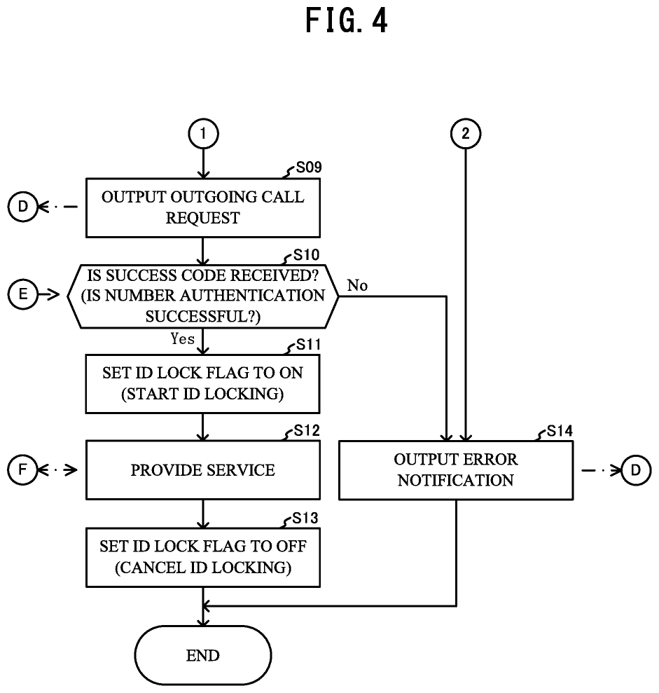

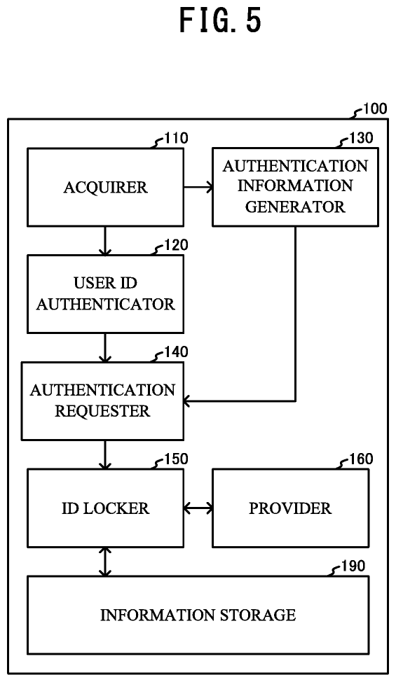

When the information communication circuit 106 of the service providing device 100 receives, from the terminal 300, a service provision request seeking the provision of the service, the CPU 101 of the service providing device 100 executes service provision processing such as that illustrated in FIG. 3 or FIG. 4. Thus, the CPU 101 illustrated in FIG. 2 functions as an acquirer 110, a user ID authenticator 120, an authentication information generator 130, an authentication requester 140, an ID locker 150, and a provider 160 illustrated in FIG. 5. The hard disk 103 functions as an information storage 190.

The acquirer 110 acquires, from the information communication circuit 106 illustrated in FIG. 2, the service provision request that the information communication circuit 106 receives from the terminal 300.

The user ID authenticator 120 performs user ID authentication that authenticates whether the user of the terminal 300 is an authorized user on the basis of the user ID of the user using the terminal 300, which is included in the service provision request acquired by the acquirer 110.

In cases in which the user ID authentication is successful, the authentication information generator 130 performs, on the phone number of the user identified by the user ID, processing according to a predetermined rule (hereinafter referred to as “number processing rule”) and then performs an irreversible conversion according to a predetermined rule (hereinafter referred to as “number conversion rule), thereby generating authentication information to be used in the number authentication.

The number processing rule is not limited and, for example, may be a rule that moves the last four digits of the phone number to the beginning, or may be a rule that inserts a specific character string and/or number between each number of the phone number. The number conversion rule is not limited provided that the conversion is irreversible and, for example, may be a rule that performs hash conversion using message digest algorithm (MD) 5.

The authentication requester 140 generates an authentication request that requests number authentication using the authentication information. The authentication request includes the authentication information generated by the authentication information generator 130.

In cases in which a service provision request including the user ID of the user using the terminal 300 is received during a service providing period in which the service is being provided to the terminal 300, for which the number authentication based on the authentication request was successful, the ID locker 150 performs ID locking that rejects the provision of the service.

The provider 160 provides the service to the terminal 300 during the period in which the ID locking is performed.

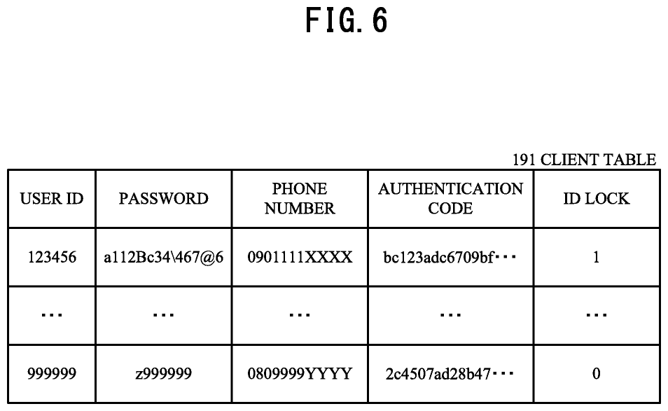

In one example, the information storage 190 stores the client table 191 illustrated in FIG. 6, in which information about clients of online banking or the like is saved. The user ID that identifies the authorized user that is a client, information expressing a password used by the user, and information expressing a phone number used by the user are associated and saved in the client table 191. In one example, the user ID, the password, and the phone number are a user ID, a password, and a phone number specified by the user when opening a bank account.

The phone number, and an authentication code that is generated when the number authentication using the phone number is requested to the authentication device 200, are associated and saved in the client table 191.

Additionally, the user ID, and an ID lock flag that indicates whether ID locking to reject service provision requests including the user ID is being performed, are associated and saved in the client table 191. In the initial state, the value of the ID lock flag is set to “0”, which indicates an OFF state in which the ID locking is not being performed.

Upon the start of the execution of the service provision processing illustrated in FIG. 3 and FIG. 4, the acquirer 110 illustrated in FIG. 5 acquires, from the information communication circuit 106, a service provision request that includes a user ID, and acquires that user ID from the service provision request (step S01).

Next, the user ID authenticator 120 performs user ID authentication on the basis of whether the user ID acquired by the acquirer 110 is saved in the client table 191 illustrated in FIG. 6. The user ID authenticator 120 searches, on the basis of the acquired user ID, the client table 191 in which user IDs of authorized users are saved. In cases in which the user ID authenticator 120 determines that the acquired user ID is saved in the client table 191, the user ID authenticator 120 determines that the user using the terminal 300 that sent the user ID is an authorized user that has a right to receive the service. As such, the user ID authentication by the user ID authenticator 120 is successful (step S02; Yes).

Thereafter, the authentication information generator 130 acquires the phone number of the user identified by the user ID by acquiring, from the client table 191, the information that expresses the phone number that is associated with the user ID (step S04).

Next, the authentication information generator 130 performs the processing according to the number processing rule and then performs the irreversible conversion according to the number conversion rule on the phone number acquired in step S04 and, as a result, generates the authentication information (step S05).

The authentication information generator 130 creates an authentication code. The authentication code is a random number that has a predetermined number of digits. The authentication information generator 130 saves the generated authentication code in the client table 191 illustrated in FIG. 6 in association with the user ID.

Then, the authentication requester 140 generates an authentication request requesting number authentication. The authentication request includes the generated authentication code and the authentication information generated in step S05. Next, the authentication requester 140 outputs the authentication request to the information communication circuit 106 illustrated in FIG. 2 with the authentication device 200 as the destination (step S06).

Thereafter, the information communication circuit 106 sends the authentication request that includes the authentication information and the authentication code to the authentication device 200. Thereafter, the information communication circuit 106 receives an acceptance code or a rejection code from the authentication device 200. The acceptance code is a code that is generated on the basis of the authentication code and notifies that the authentication request is accepted. The rejection code is a code that is generated on the basis of the authentication code and notifies that the authentication request is rejected.

A reason why the authentication device 200 rejects the authentication request is because, if a first authentication request and a second authentication request that include the same authentication information are sequentially received within a predetermined amount of time and both of the authentication requests are accepted, the number authentication may be incorrect. As an example, a case will be described in which a first authentication request seeks the authentication of a terminal used by a third party that does not have a right to receive the service, and a second authentication request seeks the authentication of the terminal 300 that is used by the authorized user. In this case, if the outgoing call of the terminal 300 used by the authorized user occurs before the outgoing call of the terminal of the third party, the authentication device 200 will cause the number authentication of the terminal of the third party received later to succeed on the basis of the caller number of the terminal 300.

To prevent this, the authentication device 200 registers the authentication information included in the first authentication request in an authentication information database for a period from the receipt of the first authentication request to when the number authentication based on the first authentication request is successful, or for a period from the receipt of the first authentication request to when the predetermined amount of time elapses. In this period, if the authentication device 200 receives the second authentication request that includes authentication information that is the same as the registered authentication information, the authentication information of the second authentication request is registered in the database. As a result, a double registration of that authentication information occurs in the database, and the authentication device 200 performs authentication information locking that rejects the second authentication request that caused the double registration. The period in which the authentication information locking is performed is referred to as the authentication information locking period, and the length of the authentication information locking period is preset so as to be sufficiently longer than the amount of time typically required from the request of an outgoing call to the completion of the outgoing call.

After the authentication request is output in step S06, when the information communication circuit 106 illustrated in FIG. 2 receives an acceptance code or a rejection code, the acquirer 110 acquires the acceptance code or the rejection code from the information communication circuit 106 (step S07).

When an acceptance code is acquired, if the authentication requester 140 determines that the authentication device 200 does not detect a double registration of the authentication information (that is, the authentication information locking is not performed) (step S08; No), the authentication requester 140 outputs an outgoing call request, requesting that an outgoing phone call be placed to the authentication device 200, to the information communication circuit 106 illustrated in FIG. 2, with the terminal 300 as the destination (step S09).

The information communication circuit 106 sends the outgoing call request to the terminal 300, and the terminal 300 that receives the outgoing call request displays a message prompting the user to perform an operation of placing an outgoing phone call to the authentication device 200. Thereafter, the terminal 300 places an outgoing phone call to the authentication device 200 in accordance with the operations of the user that views the message. The authentication device 200 generates authentication information from the phone number that is notified together with the incoming call from the terminal 300 and, then, performs number authentication on the basis of the generated authentication information and the authentication information included in the authentication request output in step S06. When the number authentication is successful, the authentication device 200 sends a success code that is generated on the basis of the authentication code included in the authentication request.

The authentication requester 140 determines whether the information communication circuit 106 received the success code from the authentication device 200 within a predetermined amount of time after the output of the outgoing call request in step S09 (step S10). The length of the predetermined amount of time used in step S10 is preset to be sufficiently longer than the amount of time typically required from the sending of an outgoing call request to the completion of the outgoing call of the terminal 300 that received the outgoing call request.

The authentication requester 140 determines that the number authentication of the terminal 300 is successful when the success code is received within the predetermined amount of time (step S10; Yes). Next, the ID locker 150 starts the ID locking by updating the value of the ID lock flag, associated with the user ID and saved in the client table illustrated in FIG. 6, to “1”, which indicates an ON state (step S11). Then, the provider 160 starts session management and also starts the provision of the service to the terminal 300 (step S12).

Next, when the provision of the service by the provider 160 is complete, the ID locker 150 updates the value of the ID lock flag associated with the user ID and saved in the client table to “0”, which indicates the OFF state, thereby canceling the ID locking (step S13). Thereafter, the ID locker 150 ends the execution of the service provision processing.

In step S02, if the user ID authenticator 120 determines that the acquired user ID is not saved in the client table 191, the user ID authentication fails (step S02; No). Next, the user ID authenticator 120 outputs an error notification to the information communication circuit 106 illustrated in FIG. 2, with the terminal 300 as the destination (step S14) and, then, ends the execution of the service provision processing. This is to prevent the provision of the service to third parties that do not have a right to receive the service.

When, in step S03, the value of the ID lock flag is the number “1”, which indicates the ON state, the ID locker 150 determines that ID locking is being performed (step S03; Yes). Thereafter, the ID locker 150 executes the processing for outputting the error notification (step S14) and, then, ends the execution of the service provision processing. This is to reject further provisions of the service.

When, in step S08, a rejection code is acquired, the authentication requester 140 determines that the authentication device 200 detects a double registration of the authentication information (that is, the authentication information locking is being performed) (step S08; Yes). Thereafter, the authentication requester 140 executes the processing for outputting the error notification (step S14) and, then, ends the execution of the service provision processing.

In step S10, when it is determined that the number authentication of the terminal 300 has failed due to a success code not being received within the predetermined amount of time (step S10; No), the authentication requester 140 performs the processing of step S14 and, then, ends the execution of the service provision processing. This is because a third party that does not have a right to receive the provision of the service may be using the terminal 300.

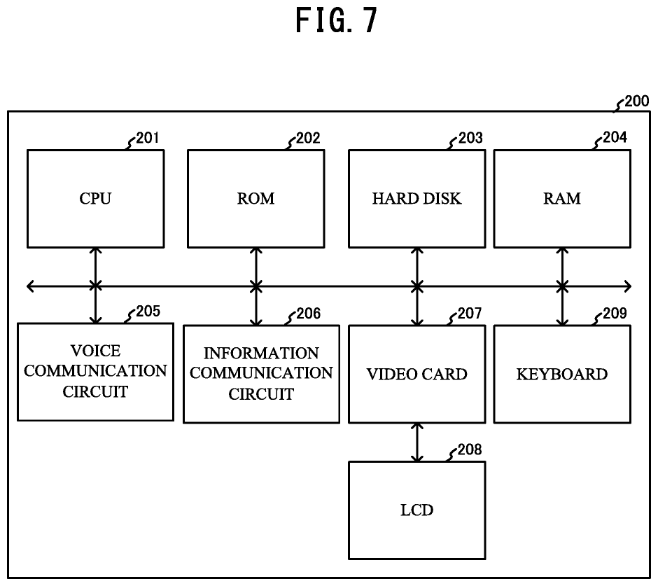

Next, the configuration of the authentication device 200, which performs the number authentication on the basis of the authentication request sent by the service providing device 100, will be described while referencing FIG. 7.

The authentication device 200 includes a CPU 201, a ROM 202, a hard disk 203, a RAM 204, an information communication circuit 206, a video card 207, an LCD 208, and a keyboard 209. The configurations of the components of the authentication device 200 are the same as the CPU 101, the ROM 102, the hard disk 103, the RAM 104, the information communication circuit 106, the video card 107, the LCD 108, and the keyboard 109 of the service providing device 100 illustrated in FIG. 2.

The authentication device 200 phone-connects to the terminal 300 via the public network PN illustrated in FIG. 1, and further includes a voice communication circuit 205 that performs voice communication.

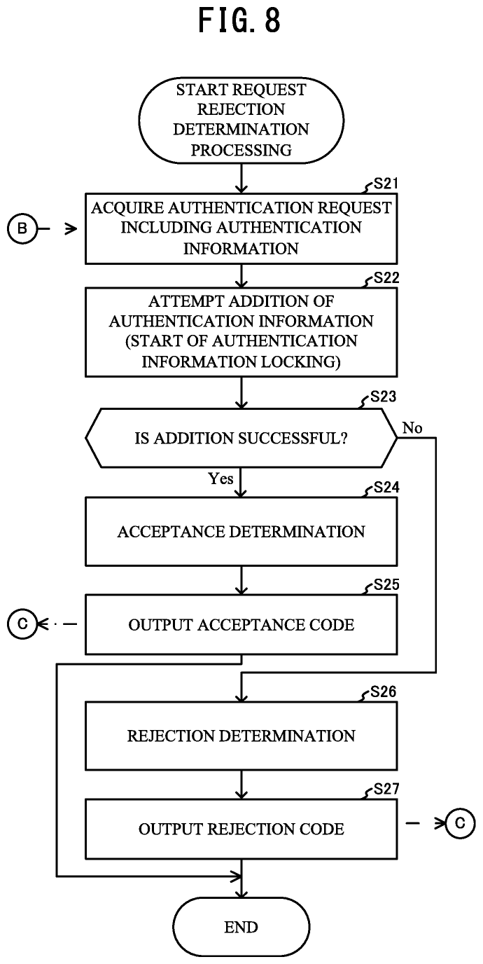

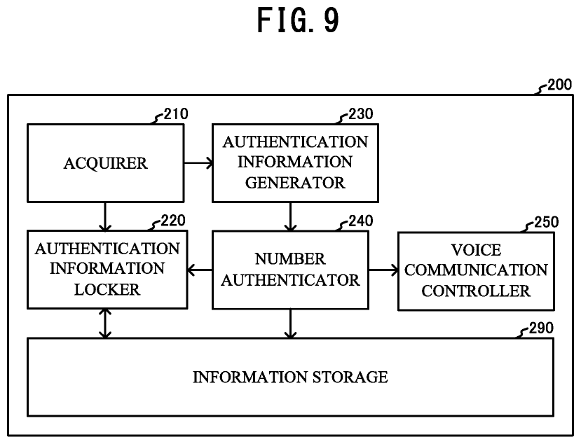

The CPU 201 of the authentication device 200 executes request rejection determination processing such as that illustrated in FIG. 8. The request rejection determination processing determines whether to reject the authentication request received from the service providing device 100. Due to this, the CPU 201 illustrated in FIG. 7 functions as an acquirer 210 and an authentication information locker 220, and the hard disk 203 functions as an information storage 290 as illustrated in FIG. 9.

The acquirer 210 acquires the authentication request that the information communication circuit 106 illustrated in FIG. 2 received from the service providing device 100. The authentication information locker 220 performs the authentication information locking on the basis of the authentication information included in the acquired authentication request.

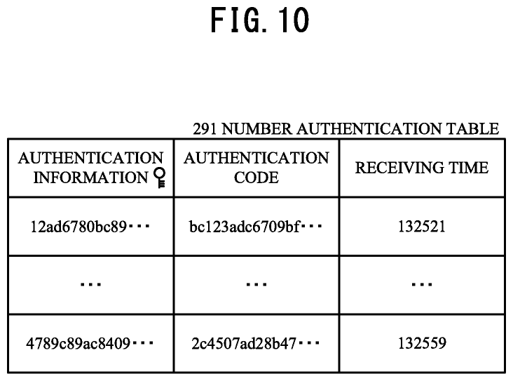

The information storage 290 stores the number authentication table 291 illustrated in FIG. 10. Information used in the number authentication is saved in the number authentication table 291. The number authentication table 291 is managed by a database management system, and one or a plurality of records are added to (that is, registered in) the number authentication table 291. The authentication information is set in the number authentication table 291 as a key that identifies a record. That is, authentication information that differ from each other are saved in the number authentication table 291 for the plurality of records that are already added. Additionally, records to be added to the number authentication table 291 are only added to the number authentication table 291 when the authentication information saved therein differs from the authentication information of all of the plurality of records already added. Conversely, when a record to be added to the number authentication table 291 is a record in which authentication information is saved that is the same as one of the plurality of records that is already added, that record is not added to the number authentication table 291.

The authentication information, the authentication code, and information expressing a receiving time of the authentication request that includes the authentication information and the authentication code are associated and saved in a record of the number authentication table 291.

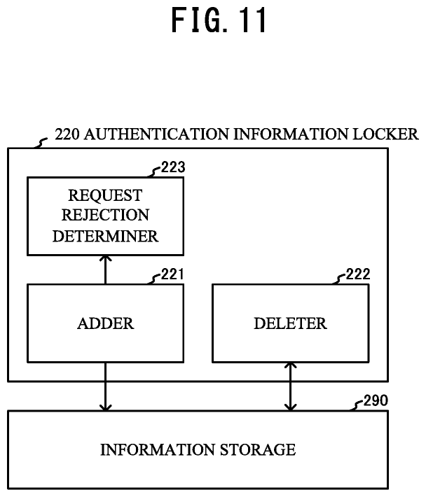

As illustrated in FIG. 11, the authentication information locker 220 includes an adder 221, a deleter 222, and a request rejection determiner 223.

The adder 221 adds, to the number authentication table 291 illustrated in FIG. 10, a record in which the authentication information and the authentication code of the authentication request acquired by the acquirer 210, and the information expressing the receiving time of the authentication request are saved.

On a predetermined cycle, the deleter 222 deletes, from the number authentication table 291, records in which a receiving time is saved that is prior to the current time by a predetermined amount of time or longer. Additionally, when the number authentication is successful, the deleter 222 deletes, from the number authentication table 291, the record in which the authentication information used in the successful number authentication is saved.

In cases in which the addition of a record by the adder 221 is successful, the request rejection determiner 223 determines to accept of the authentication request acquired by the acquirer 210 and, in cases in which the addition of the record fails, determines to reject the authentication request.

The addition of a record fails in cases in which, prior to the addition of the record, another record, which includes authentication information identical to the authentication information saved in the record to be added, is saved in the number authentication table 291, and double registration of the authentication information occurs. The addition fails because the authentication information is set as the key for the number authentication table 291. In this case, when the authentication request that includes the authentication information of the record to be added is defined as the second authentication request described above, the first authentication request, which includes the same authentication information as the authentication information of the second authentication request and for which the number authentication has not yet succeeded, is received between a time that is a predetermined amount of time earlier and the current time. In this case, since the first authentication request and the second authentication request are received within the predetermined amount of time, the authentication device 200 performs the authentication information locking to prevent mistakes of the number authentication based on the authentication information, and determines to reject the second authentication request that is received after the first authentication request.

In contrast, the addition of a record is successful in cases in which, prior to the addition of the record, another record, which includes authentication information identical to the authentication information saved in the record to be added, is not already saved in the number authentication table 291, and double registration of the authentication information does not occur. In this case, only one authentication request is received within the predetermined amount of time that includes the authentication information of the record and, as such, the authentication device 200 does not perform the authentication locking and determines to accept the authentication request.

Next, the request rejection determination processing executed by the CPU 201 of the authentication device 200 illustrated in FIG. 7 will be described while referencing FIG. 8. When the information communication circuit 206 receives, from the service providing device 100, the authentication request output in step S06 of FIG. 3, the CPU 201 starts the execution of the request rejection determination processing.

When the execution of the request rejection determination processing starts, the acquirer 210 illustrated in FIG. 9 acquires, from the information communication circuit 206, the authentication request that requests the authentication of the terminal 300 (step S21). The authentication request includes the authentication information and the authentication code of the terminal 300. Thereafter, the acquirer 210 acquires the authentication information and the authentication code form the authentication request and, then, acquires the current time from the operating system (OS), for example, and sets the acquired time as the receiving time of the authentication request and the authentication information.

Next, the adder 221 illustrated in FIG. 11 attempts to add, to the number authentication table 291 illustrated in FIG. 10, a record in which the authentication information and the authentication code acquired by the acquirer 210, and information expressing the receiving time thereof are saved (in other words, the start of the authentication information locking) (step S22).

Thereafter, if it is determined that double registration did not occur and, as such, the addition of the record is successful (step S23; Yes), the request rejection determiner 223 determines to accept the authentication request acquired in step S21 (step S24). Next, the request rejection determiner 223 creates an acceptance code by converting the authentication code, acquired by the acquirer 210, according to a predetermined rule (hereinafter referred to as “acceptance code generation rule”). The acceptance code generation rule is managed in a state of secrecy between the service providing device 100 and the authentication device 200. As such, even if a third party fraudulently acquires the authentication code, it will be difficult for that third party to generate an acceptance code from the acquired authentication code. Since it is difficult for the third party to generate an acceptance code, the third party can be prevented from sending fraudulently generated acceptance codes to the service providing device 100.

After the acceptance code is created, the request rejection determiner 223 outputs the acceptance code to the information communication circuit 206 illustrated in FIG. 7 with the service providing device 100 as the destination (step S25), and then ends the execution of the request rejection determination processing. The information communication circuit 106 sends the acceptance code to the service providing device 100.

If it is determined that double registration did occur and, as such, the addition of the record failed (step S23; No), the request rejection determiner 223 determines to reject the authentication request acquired in step S21 (step S26). Next, the request rejection determiner 223 creates a rejection code by converting the authentication code according to a predetermined rule (hereinafter referred to as “rejection code generation rule”). Then, the request rejection determiner 223 outputs the rejection code to the information communication circuit 206 with the service providing device 100 as the destination (step S27), and then ends the execution of the request rejection determination processing.

When the service providing device 100 acquires, in step S07 of FIG. 3, the acceptance code output by the authentication device 200 in step S25 of FIG. 8, the service providing device 100 outputs an outgoing call request in step S09 with the terminal 300 as the destination.

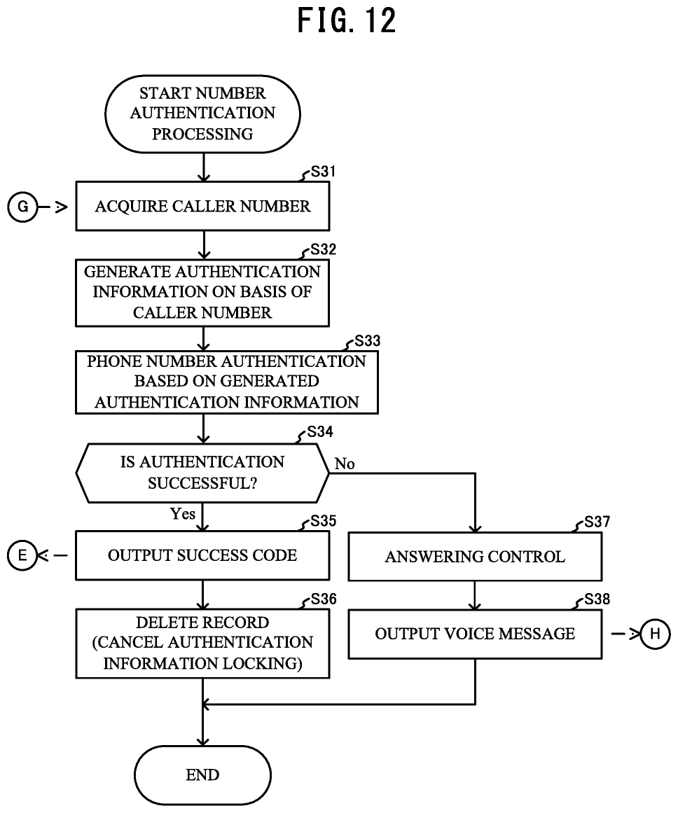

When there is an incoming call from the voice communication circuit 205 to the terminal 300, the CPU 201 of the authentication device 200 executes the number authentication processing illustrated in FIG. 12. As such, the CPU 201 further functions as an authentication information generator 230, a number authenticator 240, and a voice communication controller 250, such as illustrated in FIG. 9.

The authentication information generator 230 performs the processing according to the number processing rule and then performs the conversion according to the number conversion rule on the caller number notified that is together with the incoming call and, as a result, generates the authentication information.

In cases in which the authentication information generated on the basis of the incoming call number matches any of the authentication information saved in the number authentication table 291 illustrated in FIG. 10, the number authenticator 240 determines that the number authentication of the terminal 300 is successful. In cases in which the authentication information generated on the basis of the incoming call number does not match any of the authentication information in the number authentication table 291, the number authenticator 240 determines that the number authentication failed. That is, since the authentication information, included in authentication requests over a predetermined amount of time after the receiving time of the authentication request, is saved in the number authentication table 291, the number authenticator 240 performs the number authentication on the basis of whether the phone number, on which the authentication information is based, is notified as the caller number within the predetermined amount of time after the receiving time of the authentication request.

When the number authentication fails, the voice communication controller 250 controls the voice communication circuit 205 to answer the incoming call from the terminal 300 and deliver, to the terminal 300, speech prompting the user of the terminal 300 to call back.

When there is an incoming call from the terminal 300 to the voice communication circuit 205, the number authentication processing illustrated in FIG. 12 is started and the acquirer 210 acquires, from the voice communication circuit 205, information representing the caller number that is notified together with the incoming call to the voice communication circuit 205 (step S31).

Next, the authentication information generator 230 generates the authentication information on the basis of the acquired information that represents the caller number (step S32). Thereafter, the number authenticator 240 performs number authentication of the terminal 300 on the basis of the generated authentication information (step S33).

In the processing of performing the number authentication of step S33, the number authenticator 240 searches the number authentication table 291 illustrated in FIG. 10 for a record in which authentication information is saved that is the same as the authentication information generated by the authentication information generator 230. In cases in which the number authenticator 240 finds a record in which authentication information is saved that is the same as the generated authentication information, the terminal 300 from which the number, on which authentication information is based, is sent is determined as being used by an authorized user that has a right to receive the service, and the number authentication succeeds (step S34; Yes).

Next, the number authenticator 240 acquires the authentication code of the record that was found, and creates a success code by converting the acquired authentication code according to a predetermined rule (hereinafter referred to as “success code generation rule”). Then, the number authenticator 240 outputs the success code to the information communication circuit 206 with the service providing device 100 as the destination (step S35).

Next, the deleter 222 deletes the record that was found from the number authentication table 291 illustrated in FIG. 10, thereby canceling the authentication information locking (step S36). Then, the execution of the number authentication processing is ended without answering the incoming call from the terminal 300. This is because, provided that the caller number can be acquired, the authentication device 200 can execute the number authentication without answering the incoming call.

Note that the acceptance code generation rule, the rejection code generation rule, and the success code generation rule used in generating acceptance code output in step S25 of FIG. 8, the rejection code output in step S27 of FIG. 8, and the success code output in step S35 of FIG. 12 may by any type of rule, provided that they differ from each other. For example, the success code generation rule may be a rule that processes the authentication code by moving the first four digits of the authentication code to the end, and then hash converts the processed authentication code. In another example, the acceptance code generation rule may be a rule that processes the authentication code by moving the middle four digits of the authentication code to the beginning or the end, and then hash converts the processed authentication code. In yet another example, the rejection code generation rule may be a rule that processes the authentication code by moving the last four digits of the authentication code to the beginning, and then hash converts the processed authentication code.

A reason that the request rejection determiner 223 generates the acceptance code from the authentication code according to the acceptance code generation rule is, as described above, in such a configuration, the acceptance code generation rule is managed in a state of secrecy, which makes it difficult for a third parties to generate acceptance codes based on authentication codes that are fraudulently acquired. This is also the reason that the request rejection determiner 223 generates the rejection code according to the rejection code generation rule, the number authenticator 240 generates the success code according to the success code generation rule, and the request rejection determiner 223 generates the acceptance code according to the acceptance code generation rule. In other words, the reason for this configuration is to make it difficult for third parties to generate rejection codes and success codes by managing the rejection code generation rule and the success code generation rule in a state of secrecy. Specifically, if it is difficult for third parties to generate acceptance codes and rejection codes, third parties will not be able to easily send fraudulently generated acceptance codes and rejection codes to the service providing device 100. As a result, third parties can be prevented from sending fraudulent notifications to the service providing device 100 that the number authentication, performed as a result of the authentication device 200 accepting the authentication request, is successful in order to impersonate authorized users.

When, in step S34, the number authenticator 240 does not find a record in the number authentication table 291 illustrated in FIG. 10 on the basis of the authentication information generated on step S32, the terminal 300 is determined as being used by a third party that does not have a right to receive the service, and the number authentication fails (step S34; No).

Thereafter, the voice communication controller 250 controls the information communication circuit 206 so as to answer the incoming call (step S37). Next, the voice communication controller 250 reads, from the information storage 290, an electronic file in which a voice message prompting the user to call back is stored. Thereafter, the voice communication controller 250 outputs the voice message to the information communication circuit 206, thereby controlling the information communication circuit 206 so as to deliver the message to the caller (step S38) and, then, ends the number authentication processing.

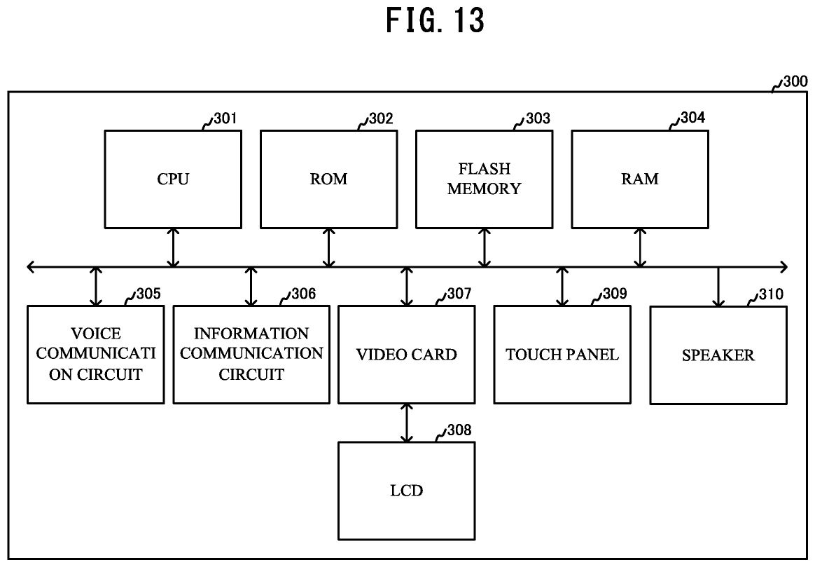

Next, the configuration of the terminal 300 that is subjected to the number authentication by the authentication device 200 will be described while referencing FIG. 13. The terminal 300 includes a CPU 301, a ROM 302, a RAM 304, an information communication circuit 306, a video card 307, and an LCD 308. The configurations of the components of the terminal 300 are the same as the CPU 101, the ROM 102, the RAM 104, the information communication circuit 106, the video card 107, and the LCD 108 of the service providing device 100 illustrated in FIG. 2.

The terminal 300 further includes a flash memory 303 in which a program is saved, an voice communication circuit 305 that has the same configuration as the voice communication circuit 205 of the authentication device 200 illustrated in FIG. 7, a touch panel 309 whereby signals corresponding to user operations are input, and a speaker 310 into which signals corresponding to user speech are input.

In accordance with a user operation, the information communication circuit 305 of the terminal 300 downloads, from a predetermined website, an application (hereinafter referred to simply as “app”) that is executed in order to use the service of the service providing device 100. The CPU 301 of the terminal 300 saves the downloaded app in the flash memory 303.

Then, in one example, when the user performs, on the touch panel 309, an operation of tapping an icon of the app that is displayed on the LCD 308, the CPU 301 starts the app in accordance with the signal input from the touch panel 309.

The first time the app is started, the CPU 301 displays a message on the LCD 308 prompting the user to input the user ID. The CPU 301 saves, in the flash memory 303, the user ID that the touch panel 309 inputs in accordance with user operations and, then, in accordance with a user operation, ends the execution of the app.

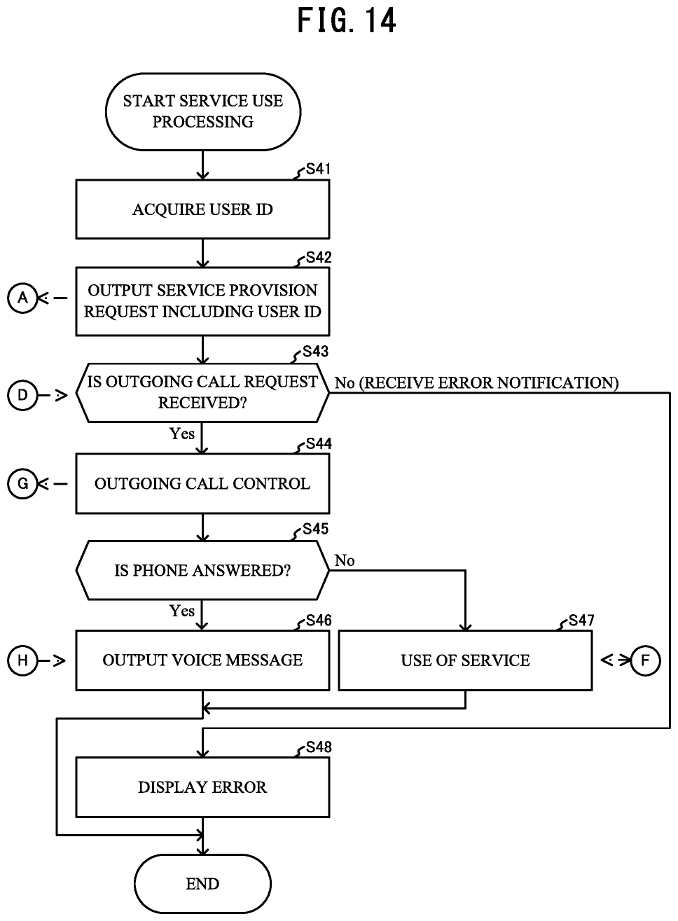

Then, when, the CPU 301 restarts the app in accordance with a user operation, service use processing, such as that illustrated in FIG. 14, for using the service of the service providing device 100 is executed.

When the execution of the service use processing starts, the CPU 301 of the terminal 300 acquires the user ID from the flash memory 303 (step S41). Next, the CPU 301 generates a service provision request including the user ID, and outputs the generated service provision request to the information communication circuit 306 with the service providing device 100 as the destination (step S42).

When, in step S01 of FIG. 3, the service providing device 100 acquires the service provision request from the terminal 300, the service providing device 100 sends an outgoing call request to the terminal 300 requesting that an outgoing phone call be placed to the authentication device 200 for the number authentication, in step S09.

When the CPU 301 of the terminal 300 determines that the outgoing call request is received by the information communication circuit 306 (step S43; Yes), the CPU 301 displays, on the LCD 308, a message prompting the user to perform an operation of placing an outgoing phone call to the authentication device 200. Thereafter, in accordance with an operation on the touch panel 309 by the user that viewed the message, the CPU 301 controls the voice communication circuit 305 to place an outgoing phone call to the authentication device 200 (step S44).

Thereafter, if, on the basis of a signal output from the voice communication circuit 305, it is detected that the authentication device 200 answered the outgoing call of the voice communication circuit 305 (step S45; Yes), the CPU 301 controls the speaker 310 to output speech delivered from the authentication device 200, namely a voice message prompting the user to call back (step S46). Then, after the outputting of the voice message is completed, the CPU 301 ends the execution of the service use processing.

In contrast, if the CPU 301 of the terminal 300 does not detect an answer within a predetermined amount of time (step S45; No), the CPU 301 controls the information communication circuit 306 to start information communication, and starts the use of the service. Thereafter, when the use of the service is ended in accordance with a user operation on the touch panel 309, the CPU 301 ends the execution of the service use processing.

If, in step S43, the CPU 301 of the terminal 300 determines that the information communication circuit 306 did not receive an outgoing call request (step S43; No) but received an error notification, the CPU 301 displays that error message on the LCD 308 illustrated in FIG. 13 (step S48). Thereafter, the CPU 301 ends the execution of the service use processing.

According to these configurations, the authentication device 200 can autonomously perform the number authentication of the terminal 300 with the incoming call from the terminal 300 as a trigger, without receiving an authentication request from the service providing device 100. As such, the need for the service providing device 100 to wait for the completion of the outgoing call before requesting number authentication by the authentication device 200, which is the case in the conventional technology, is eliminated. Therefore, there is no need for the user to operate the terminal 300 after the end of the outgoing phone call to send, to the service providing device 100, a notification of the completion of the outgoing call. As a result, the service providing system 1 of the present embodiment can reduce the operation burden on the user.

In addition, according to these configurations, the authentication device 200 can autonomously perform the number authentication with the incoming call from the terminal 300 as a trigger. As such, the need to perform polling from the terminal device 300 to the service providing device 100 and, depending on the polling, the need for the service providing device 100 to repeatedly issue requests to the authentication device 200 over the predetermined amount of time to perform the number authentication, which is the case in the conventional technology, are eliminated. Therefore, according to the service providing system 1 of the present embodiment, increases in the processing load on the service providing device 100 can be suppressed.

With conventional authentication devices, for each incoming call, authentication information is generated on the basis of the caller number and all of the generated authentication information is added to the number authentication table, even in cases in which fraudulent outgoing calls are repeatedly placed using a plurality of phone numbers in order to inhibit number authentication. Such conventional authentication devices perform number authentication by searching for the authentication information of the authorized user included in the authentication request in a number authentication table to which, not only the authentication information generated on the basis of an incoming call from the terminal of an authorized user, but also many pieces of authentication information generated on the basis of fraudulent incoming calls are added.

In contrast, the service providing device 100 according to the present embodiment generates the authentication information on the basis of the phone number that is included in the service provision request received from the terminal 300 and that is associated with the user ID for which user ID authentication is successful (steps S01 to S05 of FIG. 3). The authentication information sent from the service providing device 100 is added to the number authentication table 291 illustrated in FIG. 10 by the authentication device 200 (step S22 of FIG. 8). As such, only the authentication information generated on the basis of the phone number of the authorized user, which is needed for the number authentication, is saved in the number authentication table 291. Thereafter, the authentication device 200 performs the number authentication on the basis of whether the authentication information generated on the basis of the notified caller number is saved in the number authentication table 291 (step S33 of FIG. 12). Therefore, according to the service providing system 1 of the present embodiment, only authentication information based on the phone number of the authorized user that requires number authentication is added to the number authentication table 291. As such, the amount of data to be searched to perform the number authentication can be reduced compared to conventional authentication methods in which authentication information is added for each incoming call.

Additionally, according to these configurations, in cases in which a second authentication request is received from when a first authentication request is received to when the predetermined amount of time has elapsed or to when the number authentication based on the first authentication request is successful, the authentication device 200 determines to reject the second authentication request (step S26 of FIG. 8). As such, according to the service providing system 1 of the present embodiment, in cases in which a first authentication request is sent from the terminal of a third party and a second authentication request is sent from the terminal 300 of an authorized user, it is possible, on the basis of the outgoing call of the terminal 300, to prevent the authentication of the terminal of the third party from succeeding. That is, according to the service providing system 1 of the present embodiment, it is possible to prevent third parties from impersonating authorized users that have a right to receive the service.

According to these configurations, when the number authentication fails (step S34; No of FIG. 12), the CPU 201 of the authentication device 200 controls the voice communication controller 250 to answer the incoming call from the terminal 300 (step S37). As such, if, for example, the phone number assigned to the authentication device 200 is not a toll-free number, the communications company managing the phone number of the terminal 300 can be provided with the ability to charge the user of the terminal 300. Therefore, according to the service providing system 1 of the present embodiment, an attacker that repeatedly places outgoing phone calls to the authentication device 200 to, for example, inhibit number authentication, can be motivated to stop the attacks.

Additionally, according to these configurations, the authentication device 200 authenticates, on the basis of the caller number that is notified together with the incoming call from the terminal 300, whether the terminal 300 is being used by an authorized user. Here, since the phone number is information that is assigned to an object such as a subscriber identity module (SIM) card or a telephone device, provided that the SIM card or the telephone device is not stolen, a third party cannot easily use that phone number. In contrast, passwords and electronic keys are not information assigned to an object and, as such, are easier to use by a third party than a phone number. As such, while it is not necessary to keep phone numbers secret, information used in authentication such as passwords and electronic keys must be strictly managed so as to prevent leaks. Therefore, according to the service providing system 1 of the present embodiment, the management burden of managing, in a state of secrecy, the information used in the authentication can be reduced for both the user that uses the terminal 300 to receive the service and the service provider that manages the service providing device 100 and the authentication device 200.

According to these configurations, the service providing device 100 communicates via the internet IN illustrated in FIG. 1 and performs user ID authentication using the user ID, which is information that is not assigned to an object. The authentication device 200 is notified via the public network PN illustrated in FIG. 1 and performs number authentication using a phone number, which is information that is assigned to an object such as a SIM card or a telephone device. When, after the user ID authentication is successful (step S02; Yes of FIG. 3), the service providing device 100 acquires a success code notifying that the number authentication is successful (step S10; Yes of FIG. 4), the service providing device 100 provides the service (step S12). Therefore, according to the service providing system 1 of the present embodiment, the authentication is performed using two types of information, namely information that is assigned to an object and information that is not assigned to an object. As such, security strength can be improved compared to the conventional technology. Additionally, according to the service providing system 1 of the present embodiment, authentication is performed using information communicated via two channels, namely the internet IN and the public network PN. As such, security strength can be improved compared to the conventional technology.

### Modified Example 1 of Embodiment 1

In Embodiment 1, an example is described in which the authentication information is information obtained by subjecting the phone number of the terminal 300 used by the user to processing according to the number processing rule and then irreversible conversion according to the number conversion rule. However, the present disclosure is not limited to this example.

A configuration is possible in which the authentication information is information obtained by subjecting the phone number to one of the processing according to the number processing rule and the irreversible conversion according to the number conversion rule, or the phone number is subjected to the conversion according to the number conversion rule and then to the processing according to the number processing rule.

### Modified Example 2 of Embodiment 1

An example is described in which the service providing device 100 according to Embodiment 1 includes the user ID authenticator 120 illustrated in FIG. 5, and the user ID authenticator 120 performs the user ID authentication in step S02 of FIG. 3. The user ID authentication is determined to be successful when the user ID sent by the terminal 300 is saved in the client table 191 illustrated in FIG. 6.

The service providing device 100 according to this modified example includes a password authenticator (not illustrated in the drawings) in place of the user ID authenticator 120, and the password authenticator performs password authentication in step S02 of FIG. 3. The password authentication is determined to be successful when both the user ID and the password sent by the terminal 300 are saved in the same record of the client table 191 illustrated in FIG. 6.

### Modified Example 3 of Embodiment 1

When the CPU 301 of the terminal 300 according to Embodiment 1 determines that an outgoing call request is received (step S43; Yes of FIG. 14), the CPU 301 displays, on the LCD 308, a message prompting the user to perform an operation of placing an outgoing phone call. Then, in accordance with an operation on the touch panel 309 by the user, the CPU 301 controls the voice communication circuit 305 to place an outgoing phone call to the authentication device 200 (step S44).

However, when the CPU 301 of the terminal 300 according to this modified example determines that an outgoing call request is received (step S43; Yes), the CPU 301 controls the voice communication circuit 305 to place an outgoing phone call to the authentication device 200 without displaying a message on the LCD 308 or waiting for a user operation on the touch panel 309 (step S44).

According to these configurations, when the user performs, on the touch panel 309, an operation of tapping an icon displayed on the LCD 308 of the terminal 300, the terminal 300 starts the app. Then, when an outgoing call request is received, the terminal 300 can place an outgoing phone call without a user operation being performed, and can be subjected to the number authentication by the authentication device 200. If the number authentication is successful, the service providing device 100 provides the service to the terminal 300. Thus, according to the service providing system 1 of this modified example, the user can receive the provision of the service by performing only a single tap operation on the terminal 300.

### Modified Example 4 of Embodiment 1

As illustrated in FIG. 10, the authentication request or the receiving time of the authentication information is saved in the records of the number authentication table 291 according to Embodiment 1, and the deleter 222 of the authentication device 200 deletes, from the number authentication table 291, records in which a receiving time is saved that is prior to the current time by a predetermined amount of time or longer.

However, in this modified example, an acquisition time of the authentication information acquired by the acquirer 210 illustrated in FIG. 9 or an addition time of the record to the number authentication table 291 by the adder 221 in FIG. 11 is saved in the records of the number authentication table 291. The deleter 222 deletes, from the number authentication table 291, records in which an acquisition time or an addition time is saved that is prior to the current time by a predetermined amount of time or longer.

### Embodiment 2

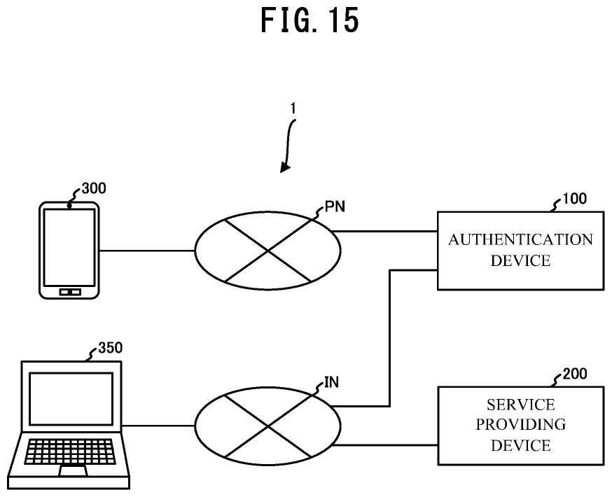

In Embodiment 1, an example is described in which the service providing system 1 includes a service providing device 100, an authentication device 200, and a terminal 300, and a user uses the terminal 300. In contrast, as illustrated in FIG. 15, the service providing system 1 according to Embodiment 2 includes a service providing device 100, an authentication device 200, a terminal 300, and a terminal 350, and a user uses both the terminal 300 and the terminal 350.

The terminal 300 is a smartphone and is not particularly limited provided that it is a phone that uses a phone number. For example, the terminal 300 may be a mobile phone that is more traditional than a feature phone such as a smartphone. Provided that the terminal 300 has a voice communication feature, the terminal 300 need not have an information communication feature. The terminal 300 may be a car phone, or may be a landline telephone such as a public telephone or a home telephone, for example.

The terminal 350 is a tablet-type personal computer, but may be a notebook-type personal computer or a desktop-type personal computer. Like the terminal 300, the terminal 350 includes a CPU, a ROM, a flash memory, a RAM, an information communication circuit, a video card, an LCD, and a touch panel (all not illustrated in the drawings), but does not include a voice communication circuit.

In Embodiment 2, with the exception of steps S44 to S46, the service use processing illustrated in FIG. 14 is executed by the terminal 350, which is a personal computer. However, the processing of steps S44 to S46, which relate to the outgoing phone call and the voice output, are executed by the terminal 300, which is a smartphone.

In the service use processing illustrated in FIG. 14, when, in step S43, which is one step before step S44, the CPU of the terminal 350 determines that an outgoing call request has been received by the information communication circuit of the terminal 350 (step S43; Yes), the CPU displays, on the LCD of the terminal 350, a message prompting the user to make a telephone connection with the authentication device 200.

Then, the user that viewed the message operates the terminal 300, which is a smartphone and, in accordance with a user operation, the CPU 301 of the terminal 300 controls the voice communication circuit 305 in FIG. 13 so as to place an outgoing call to the phone number of the authentication device 200 (step S44).

If, after placing the outgoing phone call, the number authentication based on the caller number fails, the authentication device 200 answers the outgoing call. The CPU 301 of the terminal 300 detects the answering by the authentication device 200 (step S45; Yes), and controls the speaker 310 so as to output a voice message (step S46).

In cases in which the provision of the service does not start even though a predetermined amount of time has elapsed from the receiving time of the outgoing call request or from the display time of the message, the CPU of the terminal 350, which is a personal computer, determines that the number authentication has failed, and ends the execution of the service use processing.

However, if the number authentication based on the caller number is successful, the authentication device 200 does not answer the outgoing call and the service providing device 100 starts the provision of the service. The CPU of the terminal 350 controls the information communication circuit so as to start information communication with the service providing device 100, thereby starting the use of the service (step S47). Thereafter, when the use of the service is ended, the CPU of the terminal 350 ends the execution of the service use processing.

According to these configurations, the authentication device 200 performs the number authentication using the caller number that is notified with the outgoing phone call from the terminal 300, which is performed after the terminal 350 receives the outgoing call request. As a result, it is possible to authenticate that both the terminal 300 and the terminal 350 are being used by an authorized user that has a right to use the service.

Embodiment 1, Modified Examples 1 to 4 of Embodiment 1, and Embodiment 2 of the present disclosure can be combined.

The service providing system 1 according to any of Embodiment 1, Modified Examples 1 to 4 of Embodiment 1, and Embodiment 2 of the present disclosure may include the service providing device 100 and the authentication device 200 as separate components, or may include the service providing device 100 and the authentication device 200 in an integrated configuration.

A service providing device 100 and an authentication device 200 that are provided, in advance, with configurations to realize the functions described in of any of the Embodiment 1, Modified Examples 1 to 4 of Embodiment 1, and Embodiment 2 of the present disclosure can be provided. Additionally, by applying a program, an existing service providing device and an existing authentication device can be made to function as the service providing device 100 and the authentication device 200 according to any of Embodiment 1, Modified Examples 1 to 4 of Embodiment 1, and Embodiment 2 of the present disclosure. That is, a configuration is possible in which a computer (a CPU or the like) that controls an existing service providing device and a computer of an existing authentication device execute a program to realize the various functional configurations of the service providing device 100 and the authentication device 200 described in any of Embodiment 1, Modified Examples 1 to 4 of Embodiment 1, and Embodiment 2. As a result, the computer that controls the existing service providing device and the computer of the existing authentication device can be made to function as the service providing device 100 and the authentication device 200 according to any of Embodiment 1, Modified Examples 1 to 4 of Embodiment 1, and Embodiment 2.

Any distribution method of such a program can be used. For example, the program can be stored and distributed on a recording medium such as a memory card, a CD-ROM, or a DVD-ROM, or can be distributed via a communication medium such as the internet. Note that the service providing method can be implemented using the service providing system 1.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The present disclosure is suitable for a service providing system that provides a service.

### REFERENCE SIGNS LIST

1 Service providing system
100 Service providing device
101, 102, 301 CPU
102, 202, 302 ROM
103, 203 Hard disk
104, 204, 304 RAM
106, 206, 306 Information communication circuit
107, 207, 307 Video card
108, 208, 308 LCD
109, 209 Keyboard
110, 210 Acquirer
120 User ID authenticator
130, 230 Authentication information generator
140 Authentication requester
150 ID locker
160 Provider
190, 290 Information storage
191 Client table
200 Authentication device
205, 305 Voice communication circuit
220 Authentication information locker
221 Adder
222 Deleter
223 Request rejection determiner
240 Number authenticator
250 Voice communication controller
291 Number authentication table
300, 350 Terminal
303 Flash memory
309 Touch panel
310 Speaker
PN Public network
IN Internet

1. A service providing system comprising:
an authentication device including
an information communicator that receives authentication information obtained by performing a predetermined processing on a phone number of a user that has a right to use a service, and (ii) a first authentication request and a second authentication request for seeking authentication using the authentication information,
a request rejection determiner that determines to reject the second authentication request when the second authentication request is received from when the first authentication request is received to when a predetermined amount of time has elapsed or to when the authentication based on the first authentication request is successful, and
a number authenticator that performs, when there is an incoming call from a terminal after the authentication information is received, the authentication of the terminal on the basis of the received authentication information, and information obtained by performing the predetermined processing on the phone number that is notified together with the incoming call; and
a service providing device that provides the service when the authentication is successful.

2. (canceled)

3. The service providing system according to claim 1, wherein the authentication device further includes
a table in which the authentication information is set as a key that identifies a record,
an adder that attempts to add, to the table, a record in which the received authentication information is saved, and
a deleter that, when the authentication based on the authentication information is successful or when the predetermined amount of time has elapsed from receipt or addition of the authentication information, deletes the record for which the addition has succeeded from the table,
wherein the request rejection determiner of the authentication device determines to reject the second authentication request when the addition of the record fails.

4. The service providing system according to claim 3, wherein the number authenticator of the authentication device authenticates the terminal on the basis of whether a record in which authentication information identical to the information obtained by performing the predetermined processing on the notified phone number, has been added to the table.

5. The service providing system according to any one of claim 1, wherein the authentication device further includes a voice communicator that, when the authentication of the terminal fails, answers the incoming call from the terminal.

6. A service providing method executed by a service providing system including an authentication device that performs authentication of a terminal, and a service providing device that provides a service when the authentication is successful, the method comprising:
an information communication step of receiving, by the authentication device, (i) authentication information obtained by performing a predetermined processing on a phone number of a user that has a right to use the service and (ii) a first authentication request and a second authentication request for seeking authentication using the authentication information;
a request rejection determination step of determining to reject the second authentication request when the second authentication request is received from when the first authentication request is received to when a predetermined amount of time has elapsed or to when the authentication based on the first authentication request is successful; and
a number authentication step of performing by the authentication device, when there is an incoming call from the terminal after the authentication information is received, authentication of the terminal on the basis of the received authentication information, and information obtained by performing the predetermined processing on the phone number that is notified together with the incoming call.
